(19) United States
(12) Patent Application Publication
(10) Pub. No.: US 2026/0336326 A1
(43) Pub. Date: Oct. 29, 2026

(54) TIRE

(71) Applicant: COMPAGNIE GENERALE DES ETABLISSEMENTS MICHELIN, Clermont-Ferrand (FR)

(72) Inventor: SABINE GIRONDE, Clermont-Ferrand (FR)

(21) Appl. No.: 19/118,252

(22) PCT Filed: Oct. 4, 2023
(86) PCT No.: PCT/FR2023/051532

§ 371 Date: Apr. 3, 2025

(30) Foreign Application Priority Data
Oct. 4, 2022 (FR) FR2210156

(51) Int. Cl. B60C 1/00; B60C 15/00; C08K 3/04; C08K 3/06; C08K 3/22; C08K 5/09; C08K 5/18; C08K 5/3465; C08K 5/47; C08L 7/00; C08L 9/00

(52) U.S. Cl. CPC B60C 1/00; B60C 15/0018; C08K 3/04; C08K 3/06; C08L 7/00; C08L 9/00; B60C 2001/005; C08K 2003/2296; C08K 5/09; C08K 5/18; C08K 5/3465; C08K 5/47; C08L 2205/025; C08L 2205/035

(57) ABSTRACT

The present invention relates to a tyre comprising two beads, at least one of the beads comprising a rubber composition based on:
at least one elastomer;
60 to 100 phr of reinforcing fillers, of which 15 to 70 phr are pyrolysis carbon black and 15 to 60 phr are carbon black, with a total content of carbon black and pyrolysis carbon black ranging from 60 to 90 phr; and
a crosslinking system.

### FIELD OF THE INVENTION

The present invention relates to a tyre, in particular for passenger vehicles.

### TECHNOLOGICAL BACKGROUND

Tyres for passenger vehicles usually comprise:
two beads intended to come into contact with a mounting support;
two sidewalls extending the beads radially outwards and coming together in a crown comprising a tread and a crown reinforcement;
at least one carcass reinforcement extending radially in each sidewall and axially in the crown, radially on the inside of the crown reinforcement.

Each bead comprises rubber compositions which are subjected to high stresses. They must therefore have both a sufficient degree of stiffness with good performance in terms of rolling resistance, and be sufficiently cohesive to resist external physical attacks, for instance during the mounting or removing of tyres.

In the context of constantly seeking to improve tyres and reduce their environmental impact, manufacturers aim to develop novel rubber compositions which meet the criteria set out above, among others. One of the aims of the present invention is therefore to provide a tyre, the beads of which have a good stiffness/tear strength balance without compromising hysteresis and while incorporating a not-insignificant amount of recycled material.

### BRIEF DESCRIPTION OF THE INVENTION

The present invention relates to a tyre comprising two beads, at least one of the beads comprising a rubber composition based on:
at least one elastomer;
60 to 100 phr of reinforcing fillers, of which 15 to 70 phr are pyrolysis carbon black and 15 to 60 phr are carbon black, with a total content of carbon black and pyrolysis carbon black ranging from 60 to 90 phr; and
a crosslinking system.

Other aspects of the invention are as described below and in the claims.

### DEFINITIONS

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it is thus possible for the composition to be in the completely or partially crosslinked state or in the noncrosslinked state.

The expression “part by weight per hundred parts by weight of elastomer” (or phr) should be understood as meaning, within the meaning of the present invention, the part by weight per hundred parts by weight of elastomer or of rubber, the two terms being synonymous.

In the present document, unless expressly indicated otherwise, all the percentages (%) indicated are percentages (%) by mass.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is described by the expression “from a to b”, the interval represented by the expression “between a and b” is also and preferentially described.

The expression “radial” refers to a radius of the tyre. It is within this meaning that a point P1 is said to be “radially interior” to a point P2 (or “radially on the inside of” the point P2) if it is closer to the axis of rotation of the tyre than the point P2. Conversely, a point P3 is said to be “radially exterior to” a point P4 (or “radially on the outside of” the point P4) if it is further away from the axis of rotation of the tyre than the point P4. It will be said that a movement is “radially inwards (or outwards)” when the movement is in the direction of the shorter (or longer) radii. When it is a question of radial distances, this meaning of the term also applies.

The term “radial cross section” or “radial section” is understood here to mean a cross section or a section along a plane that contains the axis of rotation of the tyre.

An “axial” direction is a direction parallel to the axis of rotation of the tyre. A point P5 is said to be “axially interior” to a point P6 (or “axially on the inside of” the point P6) if it is closer to the median plane of the tyre than the point P6. Conversely, a point P7 is said to be “axially exterior to” a point P8 (or “axially on the outside of” the point P8) if it is further from the median plane of the tyre than the point P8. The “median plane” of the tyre is the plane that is perpendicular to the axis of rotation of the tyre and that is located equidistantly from the annular reinforcing structures of each bead.

A “circumferential” direction is the direction which, in each meridian cross-section plane, is perpendicular both to a radius of the tyre and to the axial direction.

The compounds comprising carbon which are mentioned in the description can be of fossil origin or be biobased. In the latter case, they may be partially or completely derived from biomass or obtained from renewable raw materials derived from biomass. This particularly concerns polymers, plasticizers, fillers, etc.

### DETAILED DESCRIPTION OF THE INVENTION

The inventors have developed rubber compositions that meet the needs expressed.

Thus, the present invention relates to a tyre comprising two beads, at least one of the beads comprising a rubber composition based on:
at least one elastomer;
60 to 100 phr of reinforcing fillers, of which 15 to 70 phr are pyrolysis carbon black and 15 to 60 phr are carbon black, with a total content of carbon black and pyrolysis carbon black ranging from 60 to 90 phr; and
a crosslinking system.

The rubber composition may also comprise crumb rubbers and/or usual additives and processing aids.

The various constituents of the rubber composition may be as described below.

### Elastomer

The composition of use in the context of the present invention is based on at least one elastomer (or, equally, rubber).

The or each elastomer can be selected from the group consisting of diene elastomers and mixtures thereof.

The term “diene elastomer”, whether natural or synthetic, should be understood, in a known way, as meaning an elastomer consisting, at least partially (i.e., a homopolymer or a copolymer), of diene monomer units (monomers bearing two conjugated or non-conjugated carbon-carbon double bonds).

These diene elastomers can be classified into two categories: “essentially unsaturated” or “essentially saturated”. The term “essentially unsaturated” is generally understood to mean a diene elastomer derived at least in part from conjugated diene monomers having a content of sub-units or units of diene origin (conjugated dienes) which is greater than 15% (mol %); thus, diene elastomers such as butyl rubbers or copolymers of dienes and of alpha-olefins of EPDM type do not fall under the preceding definition and may particularly be termed “essentially saturated” diene elastomers (low or very low content, always less than 15%, of sub-units of diene origin).

The term “diene elastomer able to be used” is understood particularly to mean:
(a)—any homopolymer obtained by polymerization of a conjugated or non-conjugated diene monomer having from 4 to 18 carbon atoms;
(b)—any copolymer obtained by copolymerization of a conjugated or non-conjugated diene having from 4 to 18 carbon atoms with at least one other monomer.

The other monomer can be ethylene, an olefin or a conjugated or non-conjugated diene. Suitable conjugated dienes include conjugated dienes having from 4 to 12 carbon atoms, in particular 1,3-dienes, particularly such as 1,3-butadiene and isoprene.

Suitable olefins include vinylaromatic compounds having from 8 to 20 carbon atoms and aliphatic α-monoolefins having from 3 to 12 carbon atoms.

Suitable vinylaromatic compounds include, for example, styrene, ortho-, meta- or para-methylstyrene, the “vinyltoluene” commercial mixture or para-(tert-butyl)styrene.

Suitable aliphatic α-monoolefins include in particular acyclic aliphatic α-monoolefins having from 3 to 18 carbon atoms.

More particularly, the diene elastomer able to be used in the compositions can be:
(a′)—any homopolymer obtained by polymerization of a conjugated diene monomer having from 4 to 12 carbon atoms;
(b′)—any copolymer obtained by copolymerization of one or more conjugated dienes with one another or with one or more vinylaromatic compounds having from 8 to 20 carbon atoms;
(c′)—any copolymer obtained by copolymerization of one or more conjugated or non-conjugated dienes with ethylene, an α-monoolefin or a mixture thereof, for instance the elastomers obtained from ethylene, from propylene with a non-conjugated diene monomer of the abovementioned type.

Preferentially, the diene elastomer is selected from the group consisting of polybutadienes (BRs), natural rubber (NR), synthetic polyisoprenes (IRs), butadiene copolymers, isoprene copolymers and the mixtures of these elastomers. The butadiene copolymers are particularly selected from the group consisting of butadiene/styrene copolymers (SBRs).

The diene elastomer can be modified, i.e. either coupled and/or star-branched, or functionalized, or coupled and/or star-branched and simultaneously functionalized.

Thus, the diene elastomer can be coupled and/or star-branched, for example by means of a silicon or tin atom which connects the elastomer chains together.

The diene elastomer can be simultaneously or alternatively functionalized and comprise at least one functional group. The term “functional group” is understood to mean a group comprising at least one heteroatom selected from Si, N, S, O or P. Particularly suitable as functional groups are those comprising at least one function, such as: silanol, an alkoxysilane, a primary, secondary or tertiary amine which is cyclic or non-cyclic, a thiol or an epoxide.

The rubber composition of use in the context of the invention can contain just one diene elastomer or a mixture of several diene elastomers.

In some embodiments, the rubber composition of use in the context of the invention comprises one or more elastomers; it can thus comprise from 25 to 100 phr of natural rubber and from 0 to 75 phr of at least one polybutadiene, preferably from 35 to 75 phr of natural rubber and from 25 to 65 phr of at least one polybutadiene.

In some embodiments, the rubber composition of use in the context of the invention comprises, as elastomer, a mixture of natural rubber (NR) and at least one polybutadiene (BR). Preferably, the mixture consists of 50 phr of natural rubber (NR) and 50 phr of polybutadiene (BR).

### Reinforcing Filler

The composition of use in the context of the present invention comprises from 60 to 100 phr of reinforcing fillers.

The term “reinforcing filler” denotes any type of filler known for its abilities to reinforce a rubber composition that can be used in particular for the manufacture of tyres, for example organic fillers such as carbon black or pyrolysis carbon black, or inorganic fillers such as silica or alumina. It will be appreciated that crumb rubbers are not reinforcing fillers within the meaning of the present invention, and that any reinforcing fillers that they may contain are not taken into account in the calculation of the total content of reinforcing fillers in the composition.

In particular, the composition of use in the context of the present invention comprises from 15 to 70 phr of pyrolysis carbon black and from 15 to 60 phr of carbon black, with a total content of carbon black and pyrolysis carbon black ranging from 60 to 90 phr or from 60 to 80 phr or from 60 to 78 phr. The composition can therefore further comprise an inorganic reinforcing filler (e.g. silica or alumina) or an organic reinforcing filler other than the carbon black and the pyrolysis carbon black, so as to achieve a total content of reinforcing fillers ranging from 60 to 100 phr. Below 60 phr of filler, the required degree of stiffness is not achieved, and above 100 phr of filler, industrial implementation is too difficult and the level of hysteresis is too high.

In some embodiments, the composition comprises from 60 to 90 phr, preferably from 60 to 80 phr or from 60 to 78 phr, of reinforcing fillers, the reinforcing fillers consisting of a mixture of carbon black and pyrolysis carbon black. It should thus be understood that the composition comprises the carbon black and the pyrolysis carbon black as the only reinforcing fillers (the composition therefore does not comprise any inorganic reinforcing fillers or other organic reinforcing fillers). Preferably, the mixture therefore comprises from 30 to 60 phr of pyrolysis black and from 20 to 40 phr of carbon black.

The reinforcing fillers may be as described below.

### Pyrolysis Carbon Black

The composition of use in the context of the invention comprises from 15 to 70 phr of pyrolysis carbon black, preferably from 30 to 60 phr of pyrolysis carbon black.

Within the meaning of the present invention, the term “pyrolysis carbon black” means a carbon black resulting from a process for the pyrolysis of a material comprising at least a carbon-based polymer and a carbon black, hereinafter referred to as the material to be pyrolyzed, for example in the context of the recycling of such a material. The physical state in which the material to be pyrolyzed is provided is not important, whether it is in the form of a powder, granules, a strip, or any other form, in the crosslinked or noncrosslinked state.

Preferentially, the material to be pyrolyzed may be recovered from manufactured articles or from products generated during their manufacture/production (such as by-products or scrap); it is possible for these manufactured articles to be selected from the group consisting of pneumatic tyres, non-pneumatic tyres, industrial conveyor belts, transmission belts, rubber seals, rubber hoses, shoe soles and windscreen wipers. More preferentially still, the pyrolysis carbon black of use in the context of the present invention is a carbon black obtained from a pyrolysis process of which the material to be pyrolyzed is derived from manufactured articles selected from the group consisting of pneumatic tyres and non-pneumatic tyres.

In the context of the present invention, “pyrolysis” means any type of thermal decomposition in the absence of oxygen and in which the raw material is the material to be pyrolyzed as defined above. Pyrolysis carbon blacks thus differ from “industrial” and/or “ASTM-grade” carbon blacks in that the carbon-based raw material used for the pyrolysis is a material comprising at least a carbon-based polymer and a carbon black and not materials derived from petroleum cuts or derived from coal or else from oils of natural origin.

Pyrolysis carbon blacks which can be used in the context of the present invention differ from known carbon blacks such as industrial carbon blacks, in particular “furnace” carbon blacks, particularly by a higher ash content.

Preferentially, the pyrolysis carbon black which can be used in the context of the present invention has an ash content within a range extending from 5% to 30% by weight, more preferentially ranging from 8% to 25% by weight, more preferentially still from 10% to 22% by weight, relative to the total weight of the pyrolysis carbon black.

Preferentially, the pyrolysis carbon black which can be used in the context of the present invention has a sulfur content of greater than 2% by weight, preferably 2.5% to 5% by weight, relative to the total weight of the pyrolysis carbon black.

Preferentially, the pyrolysis carbon black which can be used in the context of the present invention has a zinc content of greater than or equal to 2% by weight, preferably 2.5% to 8% by weight, relative to the total weight of the pyrolysis carbon black.

Preferentially, the pyrolysis carbon black which can be used in the context of the present invention has an STSA specific surface area measured in accordance with Standard ASTM D 6556-2021 within a range extending from 20 to 200 m²/g, more preferentially extending from 30 to 90 m²/g.

Preferentially, the pyrolysis carbon black which can be used in the context of the present invention has a void volume measured in accordance with Standard ASTM D7854-21 and at a pressure of 50 MPa within a range extending from 30 to 60 ml/100 g, more preferentially extending from 35 to 55 ml/100 g.

The ash content is determined by calcination in platinum dishes in a muffle furnace at 825 °C according to the following protocol. A dish is identified in advance before each series of measurements and is tared to within 0.1 mg and the mass is denoted P0. 5 g of pyrolysis carbon black sample, weighed precisely to within 0.1 mg, are introduced into the dish; this mass is denoted P1. The dish and its contents are pre-calcined using a Bunsen burner until smoke appears and the product ignites. Once combustion of the product is complete, the dish and its contents are introduced into a muffle furnace heated to 825 °C for 1 h. After 1 h, the dish is removed from the furnace and immediately introduced into a desiccator at ambient temperature. When the dish and the ashes have returned to ambient temperature, the dish is weighed again to obtain the mass P2. Finally, it is possible to obtain the ash content (% ash) using the formula below:

$$\% ash = \frac{P 2 - P 0}{P 1 - P 0} \times 100$$

The content of zinc in the pyrolysis carbon black is realized after calcination of the sample, then take-up of the ashes in an acidic medium and assay by ICP-AES (inductively coupled plasma atomic emission spectroscopy). The ashes are obtained by carrying out the protocol above. About exactly 100 mg of ashes is taken (test sample) and introduced into a PFA (perfluoroalkoxy) tube for a HotBlock hot plate. 8 ml of 37% concentrated hydrochloric acid, 3 ml of 65% concentrated nitric acid and 0.5 ml of 40% hydrofluoric acid are then added. The tube is closed with a stopper and is heated at 130 °C for 2 h. After cooling, the contents are then transferred using ultrapure water into a 100 ml PTFE (polytetrafluoroethylene) volumetric flask already containing 2 g of boric acid (to neutralize the hydrofluoric acid). Ultrapure water is added up to the graduation mark. The solution obtained is diluted 100-fold, by taking 1 ml into a 100 ml PFTE flask already containing 8 ml of 37% concentrated hydrochloric acid, 3 ml of 65% concentrated nitric acid, 0.5 ml of 40% hydrofluoric acid and 2 g of boric acid. This diluted solution is then filtered on a 0.45 μm GHP syringe filter before being analysed by inductively coupled plasma atomic emission spectroscopy (ICP-AES). Prior to the analysis of the diluted solution, at least 5 standards are analysed by ICP-AES at zinc concentrations of 0, 0.5, 1, 2 and 5 mg/I. These standards were prepared in 100 ml volumetric flasks, by dilution of a commercial solution certified to a zinc concentration of 1 g/l.

These volumetric flasks already contain 8 ml of 37% concentrated hydrochloric acid, 3 ml of 65% concentrated nitric acid, 0.5 ml of 40% hydrofluoric acid and 2 g of boric acid. The standard solutions are analysed by ICP-AES at a wavelength of λZn=202.613 nm. For each standard concentration (c), the intensity of the zinc signal IZn is plotted on a graph IZn=f(c), which corresponds to the calibration straight line (of type y=ax+b). The solution of the sample (diluted solution) of unknown concentration is then measured under the same conditions as the standards. The measured intensity is linked to the concentration using the previously obtained calibration straight line. The concentration [c]ash in % by mass is thus obtained directly by the software, since the test sample and the volume have been previously recorded. The concentration of zinc in the pyrolysis black [c]black in % by mass is obtained by the following equation:

$${[ c ]}_{black} = {[ c ]}_{ash} * 100 * \% ash$$

The content of sulfur in the pyrolysis carbon blacks is determined using a LECO furnace. LECO sulfur analysers are designed to measure, in particular, the content of sulfur in organic and/or inorganic materials by combustion and nondispersive infrared detection. Before measuring the content of sulfur in the sample, the boats are cleaned and the furnace is calibrated. The boats for the LECO furnace are cleaned beforehand: this involves analysing the empty boat, under the same conditions as the samples. The calibration curve is prepared using a commercial standard called “BBOT” having a purity of greater than 99.99% and a guaranteed content of carbon (C), hydrogen (H), nitrogen (N), oxygen (O) and sulfur (S). This content is as follows: C %: 72.52; H %: 6.09; N %: 6.51; O %: 7.43 and S %: 7.44. About exactly 10 3, 20±3 and 40±3 mg of BBOT are weighed into a boat. The standard/boat assembly is introduced into the combustion furnace, regulated at 1350 °C under pure oxygen. The combination of the temperature of the furnace and the analysis flow rate causes the combustion of the sample and the release of sulfur and/or carbon in the form of SO₂(g). After a time of 20 s, oxygen starts to flow through the lance in order to accelerate the combustion of materials that are difficult to burn. The sulfur and/or the carbon, in the form of SO₂(g), are entrained by a stream of oxygen through the infrared detection cells. The instrument software plots a straight line linking the mass of standard introduced and the observed response (area) on the detector. A calibration straight line is thus obtained. After carefully cleaning the sampling equipment, about exactly 80±5 mg of pyrolysis carbon black is weighed and introduced into a boat for the LECO furnace. The observed area of the SO₂ peak is linked to the concentration using the calibration straight line. Using the mass of sample introduced into the boat, the instrument software then calculates the % by mass of sulfur in the sample.

Pyrolysis carbon blacks are sold for example by BlackBear under the reference “BBCT30” or by Scandinavian Enviro Systems under the reference “P550”.

### Carbon Black

The composition of use in the context of the invention comprises from 15 to 60 phr of carbon black, preferably from 20 to 40 phr of carbon black.

Suitable carbon blacks include all carbon blacks, particularly the blacks conventionally used in tyres or their treads, in particular industrial carbon blacks, more specifically “furnace” carbon blacks.

Among the carbon blacks, mention will more particularly be made of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks. The carbon blacks can be used in the isolated state, as available commercially, or in any other form, for example as support for some of the rubber additives used. The carbon blacks might, for example, be already incorporated into the diene elastomer, notably an isoprene elastomer, in the form of a masterbatch (see, for example, patent applications WO 97/36724-A2 and WO 99/16600-A1).

### Reinforcing Inorganic Filler

The composition of use in the context of the invention may comprise a reinforcing inorganic filler.

The term “reinforcing inorganic filler” should be understood here as meaning any inorganic or mineral filler, regardless of its colour and its origin (natural or synthetic), also known as “white” filler, “clear” filler or even “non-black” filler in contrast to carbon black, which is capable of reinforcing, by itself alone, without means other than an intermediate coupling agent, a rubber composition intended for the manufacture of tyres. In a known manner, some reinforcing inorganic fillers can be characterized in particular by the presence of hydroxyl (—OH) groups at their surface.

Mineral fillers of the siliceous type, preferentially silica (SiO₂), or of the aluminous type, in particular alumina (Al₂O₃), are particularly suitable as reinforcing inorganic fillers. The silica used may be any reinforcing silica known to those skilled in the art, in particular any precipitated or fumed silica having a BET specific surface area and also a CTAB specific surface area both of less than 450 m²/g, preferably in a range extending from 30 to 400 m²/g, in particular from 60 to 300 m²/g.

Use may be made of any type of precipitated silica, in particular highly dispersible precipitated silicas (HDS, for “highly dispersible silica”). These precipitated silicas, which are or are not highly dispersible, are well known to those skilled in the art. Mention may be made, for example, of the silicas described in applications WO 03/016215-A1 and WO 03/016387-A1. Among the commercial HDS silicas, use may particularly be made of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The BET specific surface area of the silica is determined in a known manner by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160 °C—relative pressure p/po range: 0.05 to 0.17). The CTAB specific surface area of the silica is determined according to the French Standard NF T 45-007 of November 1987 (method B).

Mention may also be made, as other examples of inorganic fillers capable of being used in the compositions, of mineral fillers of the aluminous type, in particular alumina (Al₂O₃), aluminium oxides, aluminium hydroxides, aluminosilicates, titanium oxides, silicon carbides or silicon nitrides, all of the reinforcing type as described, for example, in patent applications WO 99/28376-A2, WO 00/73372-A1, WO 02/053634-A1, WO2004/003067-A1, WO 2004/056915-A2, U.S. Pat. No. 6,610,261-B1 and U.S. Pat. No. 6,747,087-B2. Mention may in particular be made of the aluminas Baikalox A125 or CR125 (Baikowski), APA-100RDX (Condea), Aluminoxid C (Evonik) or AKP-G015 (Sumitomo Chemicals).

The physical state in which the reinforcing inorganic filler is provided is not important, whether it is in the form of a powder, of micropearls, of granules or else of beads or any other appropriate densified form. Of course, the term “reinforcing inorganic filler” is also understood to mean mixtures of different reinforcing inorganic fillers, in particular of silicas as described above.

Those skilled in the art will understand that, as a replacement for the reinforcing inorganic filler described above, a reinforcing filler of another nature may be used, provided that this reinforcing filler of another nature is covered with an inorganic layer such as silica, or includes on its surface functional sites, in particular hydroxyl sites, requiring the use of a coupling agent to establish the bond between this reinforcing filler and the diene elastomer. By way of example, mention may be made of carbon blacks partially or totally covered with silica, or carbon blacks modified with silica, such as, but not limited to, fillers of the Ecoblack® type in the CRX2000 series or in the CRX4000 series from Cabot Corporation.

Those skilled in the art will know how to adjust the total content of reinforcing filler according to the use in question, in particular according to the type of tyres in question, for example a tyre for a motorbike, for a passenger vehicle or for a utility vehicle, such as a van or heavy-duty vehicle.

In order to couple the reinforcing inorganic filler to the diene elastomer, use may be made, in a well-known manner, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of (symmetrical or asymmetrical) organosilane polysulfides, such as
bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl)propyl) octanethioate sold by Momentive under the name NXT Silane. More preferentially, the organosilane is an organosilane polysulfide.

Those skilled in the art can find examples of coupling agents in the following documents: WO 02/083782, WO 02/30939, WO 02/31041, WO 2007/061550, WO 2006/125532, WO 2006/125533, WO 2006/125534, U.S. Pat. No. 6,849,754, WO 99/09036, WO 2006/023815, WO 2007/098080, WO 2010/072685 and WO 2008/055986.

The content of coupling agent preferentially represents from 0.5% to 15% by weight relative to the amount of reinforcing inorganic filler, preferably from 4% to 12%, more preferably from 6% to 10%, by weight relative to the amount of reinforcing inorganic filler. Typically, the content of coupling agent is less than 20 phr, preferentially within a range extending from 6 to 17 phr, preferably from 8 to 15 phr. This content can easily be adjusted by those skilled in the art according to the content of inorganic filler used in the composition.

The composition may also comprise, in addition to the coupling agents, coupling activators, agents for covering the inorganic fillers or more generally processing aids capable, in a known manner, by virtue of an improvement in the dispersion of the filler in the rubber matrix and of a lowering in the viscosity of the compositions, of improving their ease of processing in the raw state, these processing aids being, for example, hydrolysable silanes such as alkylalkoxysilanes (in particular alkyltriethoxysilanes), polyols, polyethers (for example polyethylene glycols), primary, secondary or tertiary amines (for example trialkanolamines), hydroxylated or hydrolysable POSs, for example α,ω-dihydroxypolyorganosiloxanes (in particular α,ω-dihydroxypolydimethylsiloxanes), or fatty acids, for instance stearic acid.

### Other Organic Fillers

Mention may be made, as examples of organic fillers other than carbon blacks and pyrolysis carbon blacks, of functionalized polyvinyl organic fillers, such as described in applications WO 2006/069792-A1, WO 2006/069793-A1, WO 2008/003434-A1 and WO 2008/003435-A1.

### Rubber Crumb

The composition of use in the context of the invention may comprise crumb rubbers (abbreviated to “crumb” in the remainder of the text). Thus, the composition typically comprises from 0 to 20 phr of crumb rubber.

In some embodiments, the composition does not comprise crumb rubber.

In some embodiments, the composition comprises crumb rubbers, the content of which in the composition is greater than 0 phr and less than or equal to 20 phr, for example from 1 to 20 phr or 10 to 20 phr.

The crumb is in the form of granules, optionally made into a sheet of rubber. Generally, crumb rubbers result from a grinding or from a micronization of cured rubber compositions already used for a first application, for example in tyres; they are a product of the recycling of the materials. The crumb thus preferably consists of a composition based on at least one elastomer and a filler. The crumb is preferably in the form of microparticles.

The term “microparticles” is intended to mean particles which have a size, namely their diameter in the case of spherical particles or their largest dimension in the case of anisometric particles, of a few tens of or a few hundred microns.

The crumbs preferably consist of a composition based on an elastomer and a filler. They may also comprise all the ingredients normally used in rubber compositions, such as plasticizers, antioxidants, vulcanization additives, etc.

Thus, the crumb comprises an elastomer, preferentially a diene elastomer. This elastomer preferentially represents at least 30% by mass, more preferentially at least 35% by mass, even more preferentially at least 45% by mass relative to the weight of the crumb, said percentage being determined according to Standard ASTM E1 131. It is preferentially selected from the group consisting of polybutadienes, polyisoprenes including natural rubber, butadiene copolymers and isoprene copolymers. More preferentially, the molar content of sub-units of diene origin (conjugated dienes) present in the diene elastomer is greater than 50%, preferably between 50% and 70%.

According to a preferential embodiment of the invention, the crumb contains between 5% and 80% by mass of filler, more preferentially between 10% and 75% and very preferentially between 15% and 70%.

The term “filler” is understood here to mean any type of filler, whether it is reinforcing (typically having nanometric particles, preferentially with a weight-average size of less than 500 nm, in particular between 20 and 200 nm) or whether it is non-reinforcing or inert (typically having micrometric particles, preferentially with a weight-average size of greater than 1 μm, for example between 2 and 200 μm). The weight-average size of the nanometric particles is measured in a manner well known to those skilled in the art (by way of example, according to application WO 2009/083160 paragraph 1.1). The weight-average size of the micrometric particles can be determined by mechanical sieving.

Mention will in particular be made, as examples of fillers known as reinforcing to those skilled in the art, of carbon black or of a reinforcing inorganic filler, such as silica or alumina in the presence of a coupling agent, or mixtures thereof.

According to a preferential embodiment of the invention, the crumb comprises, by way of filler, a reinforcing filler, in particular a carbon black or a mixture of carbon blacks.

The carbon black or the mixture of carbon blacks preferentially represents more than 50%, more preferentially more than 80%, even more preferentially more than 90% by mass relative to the weight of the reinforcing filler of the crumb. According to a more preferential embodiment, the reinforcing filler consists of a carbon black or a mixture of carbon blacks.

Very preferentially, the carbon black is present in the crumb at a content ranging from 20% to 40% by mass, more preferentially from 25% to 35% by mass.

All carbon blacks, in particular blacks of the HAF, ISAF, SAF, FF, FEF, GPF and SRF type, conventionally used in rubber compositions for tyres (“tyre-grade” blacks) are suitable as carbon blacks.

The crumb can contain all the other usual additives which participate in a rubber composition, in particular for a tyre. Among these usual additives, mention may be made of liquid or solid plasticizers, non-reinforcing fillers such as chalk, kaolin, protective agents, vulcanization agents. These additives may also be in the crumb in the form of a residue or of a derivative, since they were able to react during the steps of manufacturing the composition or of crosslinking the composition from which the crumb is derived.

As regards the constituents of the crumb, it is preferable, for the requirements of the invention, for the crumb to have an acetone extract of between 3% and 30% by weight, more preferentially within a range extending from 5% to 25% by weight.

It is also preferable for the crumb to have a chloroform extract of between 5% and 85% by weight, more preferentially within a range extending from 5% to 50% by weight.

The crumbs can be simple ground/micronized rubber materials, without other treatment. It is also known that these crumbs can undergo a treatment in order to modify them. This treatment can consist of a chemical functionalization or devulcanization modification. It can also be a thermomechanical, thermochemical, biological or other similar treatment. The grinding can be carried out by various technologies, in particular cryogenic impact micronization technologies, which make it possible to obtain particles of small size on rubber materials. Commercial items of equipment, such as the CUM150 mill from Netzsch or the CW250 mill from Alpine, can be used.

According to a first embodiment of the invention, it is preferable to use a crumb which has a morphology modified by thermal and/or mechanical and/or biological and/or chemical treatment.

According to this first embodiment, it is preferable for the crumb to have an acetone extract of between 5% and 20% by weight, more preferentially within a range extending from 10% to 18% by weight. Likewise, it is preferable for the crumb to have a chloroform extract of between 15% and 85% by weight, more preferentially within a range extending from 15% to 50% by weight. Preferably, the chloroform extract of the crumb rubber has a weight-average molecular weight (Mw) of greater than 10 000 g/mol, preferably of greater than 20 000 g/mol and more preferentially of greater than 30 000 g/mol.

According to the first embodiment, it is preferable for the ratio of the chloroform extract to the acetone extract, expressed as weight percentage, to be greater than or equal to 1.5, preferably greater than 2.

Likewise preferably according to this first embodiment, the crumb has a Mooney viscosity (conventionally expressed in Mooney units, MU) of between 40 and 90, preferably between 45 and 75 and more preferentially between 50 and 70.

According to a second embodiment of the invention, it is possible to use a crumb which has not undergone any modification by thermal and/or mechanical and/or biological and/or chemical treatment.

According to this second embodiment, it is preferable for the crumb to have an acetone extract of between 3% and 15% by weight, more preferentially within a range extending from 3% to 10% by weight. Likewise, it is preferable for the crumb to have a chloroform extract of between 3% and 20% by weight, more preferentially within a range extending from 5% to 15% by weight. Preferentially, the chloroform extract of the crumb rubber has a weight-average molecular weight (Mw) of less than 10 000 g/mol, preferably of less than 8000 g/mol.

According to the second embodiment, it is preferable for the ratio of the chloroform extract to the acetone extract, expressed as weight percentage, to be less than 1.5.

Likewise preferably according to this second embodiment, the crumb has an average particle size (D50) of between 10 and 400 μm, preferentially between 50 and 350 μm and more preferentially between 70 and 300 μm.

Crumb rubbers of use for the requirements of the invention are commercially available, for example under the trade name PolyDyne sold by Lehigh Technologies.

### Crosslinking System

The composition of use in the context of the invention comprises a crosslinking system. The crosslinking system may be any type of system known to those skilled in the art in the field of rubber compositions for tyres. It can in particular be based on sulfur and/or on peroxide and/or on bismaleimides.

Preferentially, the crosslinking system is based on sulfur; it is then referred to as a vulcanization system. The sulfur can be contributed in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

Sulfur is used in a preferential content of between 0.5 and 10 phr, in particular between 1 and 5 phr. The vulcanization accelerator is used in a preferential content of between 0.5 and 10 phr, more preferentially between 0.5 and 5.0 phr.

Use may be made, as accelerator, of any compound that is capable of acting as an accelerator of the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

### Usual Additives and Processing Aids

The composition of use in the context of the invention may also comprise all or some of the usual additives and processing aids which are known to those skilled in the art and are customarily used in rubber-compositions for tyres, for instance plasticizers (such as plasticizing oils and/or plasticizing resins having or not having a tackifying nature), non-reinforcing fillers, pigments, protective agents such as anti-ozone waxes, chemical anti-ozonants, antioxidants, anti-fatigue agents, reinforcing resins (as described, for example, in application WO 02/10269).

In some embodiments, the composition of use in the context of the present invention comprises a plasticizer. The content of plasticizer is then greater than 0 and less than or equal to 10 phr, for example from 1 to 5 phr.

The plasticizer is preferably selected from hydrocarbon resins, plasticizing oils and mixtures thereof.

Plasticizing oils selected from the group consisting of naphthenic oils (of high or low viscosity, in particular hydrogenated or non-hydrogenated), paraffinic oils, MES (Medium Extracted Solvate) oils, TDAE (Treated Distillate Aromatic Extract) oils, RAE (Residual Aromatic Extract) oils, TRAE (Treated Residual Aromatic Extract) oils, SRAE (Safety Residual Aromatic Extract) oils, mineral oils, vegetable oils, ether plasticizers, ester plasticizers, phosphate plasticizers, sulfonate plasticizers, and mixtures of these compounds, are particularly suitable.

Hydrocarbon-based resins, also known as hydrocarbon plasticizing resins, are polymers that are well known to those skilled in the art, essentially based on carbon and hydrogen but which may include other types of atoms, for example oxygen, and can be used in particular as plasticizers or tackifiers in polymeric matrices. They are by nature at least partially miscible (i.e. compatible) at the contents used with the polymer compositions for which they are intended, so as to act as true diluents. They have been described, for example, in the book entitled “Hydrocarbon Resins” by R. Mildenberg, M. Zander and G. Collin (New York, V C H, 1997, ISBN 3-527-28617-9), Chapter 5 of which is devoted to their applications, particularly in the tyre rubber engineering field (5.5. “Rubber Tires and Mechanical Goods”). In a known manner, these hydrocarbon resins can also be described as thermoplastic resins in the sense that they soften when heated and can thus be moulded.

The softening point of the hydrocarbon resins is measured according to Standard ISO 4625 (“ring and ball” method). The Tg is measured according to Standard ASTM D3418 (1999). The macrostructure (Mw, Mn and PDI) of the hydrocarbon resin is determined by size exclusion chromatography (SEC); solvent tetrahydrofuran; temperature 35 °C; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower). The hydrocarbon resins may be aliphatic, aromatic or of the aliphatic/aromatic type, i.e. based on aliphatic and/or aromatic monomers. They may be natural or synthetic and may or may not be petroleum-based (if such is the case, they are also known as petroleum resins).

Examples of aromatic monomers that are suitable include styrene, α-methylstyrene, indene, ortho-, meta-, para-methylstyrene, vinyltoluene, para-tert-butylstyrene, methoxystyrenes, chlorostyrenes, vinylmesitylene, divinylbenzene, vinylnaphthalene and any vinylaromatic monomer derived from a C9 cut (or more generally from a C8 to C10 cut). Preferably, the vinylaromatic monomer is styrene or a vinylaromatic monomer derived from a C9 cut (or more generally from a C8 to C10 cut). Preferably, the vinylaromatic monomer is the minor monomer, expressed as a mole fraction, in the copolymer under consideration.

According to a particularly preferential embodiment, the hydrocarbon plasticizing resin is selected from the group consisting of cyclopentadiene (abbreviated to CPD) or dicyclopentadiene (abbreviated to DCPD) homopolymer or copolymer resins, terpene homopolymer or copolymer resins, terpene phenol homopolymer or copolymer resins, C5 cut homopolymer or copolymer resins, C9 cut homopolymer or copolymer resins, α-methylstyrene homopolymer and copolymer resins and mixtures of these resins.

The term “terpene” groups together here, in a known way, α-pinene, β-pinene and limonene monomers; the limonene monomer exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Mention will in particular be made, among the above hydrocarbon plasticizing resins, of α-pinene, β-pinene, dipentene or polylimonene homopolymer or copolymer resins.

High-Tg hydrocarbon resins are known to be thermoplastic hydrocarbon resins with a Tg of greater than 20 °C.

Preferably, the plasticizing resin is a high-Tg hydrocarbon plasticizing resin having at least any one of the following features:
a Tg of greater than 30 °C;
a number-average molecular weight (Mn) of between 300 and 2000 g/mol, more preferentially between 400 and 1500 g/mol;
a polydispersity index (PDI) of less than 3, more preferentially of less than 2 (as a reminder: PDI=Mw/Mn with Mw being the weight-average molecular weight).

More preferentially, this high-Tg hydrocarbon plasticizing resin has all of the above preferential features.

The above preferential high-Tg hydrocarbon resins are well known to those skilled in the art and are commercially available, for example sold, as regards:
polylimonene resins: by DRT under the name Dercolyte L120 (Mn=625 g/mol; Mw=1010 g/mol; PDI=1.6; Tg=72 °C) or by Arizona under the name Sylvagum TR7125C (Mn=630 g/mol; Mw=950 g/mol; PDI=1.5; Tg=70 °C);
C5 cut/vinylaromatic copolymer resins, in particular C5 cut/styrene or C5 cut/C9 cut: by Neville Chemical Company under the names Super Nevtac 78, Super Nevtac 85 or Super Nevtac 99, by Goodyear Chemicals under the name Wingtack Extra, by Kolon under the names Hikorez T1095 and Hikorez T1100, by Exxon under the names Escorez 2101 and Escorez 1273;
limonene/styrene copolymer resins: by DRT under the name Dercolyte TS 105 from DRT, by Arizona Chemical Company under the names ZT115LT and ZT5100.

Mention may also be made, as examples of other preferential resins, of phenol-modified α-methylstyrene resins. In order to characterize these phenol-modified resins, it should be remembered that a number referred to as “hydroxyl number” (measured according to Standard ISO 4326 and expressed in mg KOH/g) is used in a known way. α-Methylstyrene resins, in particular phenol-modified ones, are well known to those skilled in the art and are commercially available, for example sold by Arizona Chemical under the names Sylvares SA 100 (Mn=660 g/mol; PDI=1.5; Tg=53 °C); Sylvares SA 120 (Mn=1030 g/mol; PDI=1.9; Tg=64 °C); Sylvares 540 (Mn=620 g/mol; PDI=1.3; Tg=36 °C; hydroxyl number=56 mg KOH/g); and Silvares 600 (Mn=850 g/mol; PDI=1.4; Tg=50 °C; hydroxyl number=31 mg KOH/g).

Mention may also be made of the resins of the alkylphenol family, such as octylphenol formol (OPF), which are available for example under the name SP1068 from SI Group, and also oleorosins, such as those provided by Costa Irmaos.

### Manufacture of the Compositions

The rubber composition of use in the context of the invention is manufactured in appropriate mixers using two successive preparation phases that are well known to those skilled in the art:
a first phase of thermomechanical working or kneading (known as the “non-productive” phase), which can be performed in a single thermomechanical step during which all the necessary constituents, in particular the elastomer matrix, the fillers and the various other optional additives, with the exception of the crosslinking system, are introduced into an appropriate mixer, such as a standard internal mixer (for example of Banbury type). The incorporation of the filler into the elastomer may be performed in one or more portions while thermomechanically kneading. If the filler is already incorporated, totally or partially, in the elastomer in the form of a masterbatch, as is described, for example, in the applications WO 97/36724 or WO 99/16600, it is the masterbatch which is directly kneaded and, where appropriate, the other elastomers or fillers present in the composition which are not in masterbatch form, and also the various other optional additives, with the exception of the crosslinking system, are incorporated.

The non-productive phase is carried out at high temperature, up to a maximum temperature of between 130 °C and 170 °C, for a period of time generally of between 2 and 10 minutes.
a second phase of mechanical working (known as the “productive” phase), which is performed in an external mixer, such as an open mill, after cooling the mixture obtained during the first non-productive phase down to a lower temperature, typically of less than 110 °C, for example between 40 °C and 100 °C. The crosslinking system is then incorporated and the combined mixture is then mixed for a few minutes, for example between 1 and 30 min.

The final composition thus obtained is subsequently calendered, for example in the form of a sheet or of a slab, in particular for a laboratory characterization, or else extruded in the form of a rubber semi-finished product (or profiled element) element which can be used, for example, as an inner layer in a tyre.

The composition may be either in the uncured state (before crosslinking or vulcanization) or in the cured state (after crosslinking or vulcanization), or may be a semi-finished product which can be used in a tyre.

The crosslinking of the composition may be performed in a manner known to those skilled in the art, for example at a temperature of between 130 °C and 200 °C, preferably under pressure, for a sufficient time which can vary, for example, between 5 and 90 min. The examples that follow are given by way of illustration but must in no way be considered to limit the present invention.

### Tyres

In accordance with the invention, the compositions described previously are particularly useful for being incorporated into at least one of the tyre beads and preferably into both tyre beads.

The bead of a tyre, also known as the “bead zone”, is one of the three main areas of a tyre (crown, sidewall and bead).

More specifically, the bead is the portion of the tyre intended to allow the attachment of the tyre to a mounting support, for example a wheel comprising a rim. Thus, each bead is in particular intended to be in contact with a flange of the rim allowing it to be attached. Thus, the bead may be radially delimited on the inside by the radially innermost point of the tyre and radially delimited on the outside by the radially outermost point of the outer surface of the tyre bead to be in contact with a measuring rim of the tyre according to the ETRTO (European Tyre and Rim Technical Organization) 2021 standard manual when the tyre is inflated to its nominal pressure on this measuring rim.

In some embodiments, the tyre comprises a carcass reinforcement comprising at least one carcass layer anchored in each bead, winding around a circumferential reinforcing element of each bead such that an axially interior portion of the carcass layer anchored in each bead is arranged axially on the inside of an axially exterior portion of the carcass layer anchored in each bead.

In these embodiments, the bead is relatively stressed by the carcass reinforcement due to being wound therein. Thus, in order to ensure sufficient strength of the rubber composition in these particularly stressed embodiments, the rubber composition typically comprises a plurality of elastomers; in particular, it may comprise from 25 to 60 phr of natural rubber and from 40 to 75 phr of at least one polybutadiene. The content of reinforcing fillers of the composition is as described previously. More particularly, in some embodiments, the composition comprises from 60 to 90 phr, preferably from 60 to 80 phr or from 60 to 78 phr, of reinforcing fillers, the reinforcing fillers consisting of a mixture of carbon black and pyrolysis carbon black. Preferably, the mixture therefore comprises from 30 to 60 phr of pyrolysis black and from 20 to 40 phr of carbon black.

In other embodiments, the tyre comprises a carcass reinforcement comprising at least one carcass layer anchored in each bead, each bead comprising an axially interior circumferential reinforcing element arranged axially on the inside of the carcass layer anchored in each bead and an axially exterior circumferential reinforcing element arranged axially on the outside of the carcass layer anchored in each bead.

In these other embodiments, the bead is relatively unstressed by the carcass reinforcement due to being anchored without winding. Thus, the rubber composition in these other, relatively unstressed embodiments advantageously comprises a higher proportion of natural rubber. The composition may thus comprise one or more elastomers, in particular from 40 to 100 phr of natural rubber and from 0 to 60 phr of at least one polybutadiene. The content of reinforcing fillers of the composition is as described previously. More particularly, in some embodiments, the composition comprises from 60 to 90 phr, preferably from 60 to 80 phr or from 60 to 78 phr, of reinforcing fillers, the reinforcing fillers consisting of a mixture of carbon black and pyrolysis carbon black. Preferably, the mixture therefore comprises from 30 to 60 phr of pyrolysis black and from 20 to 40 phr of carbon black.

In particularly advantageous embodiments, the or each bead comprises a tyre seating layer intended to be in contact with a mounting support for the tyre when the tyre is mounted on the mounting support, the seating layer comprising the rubber composition, preferably consisting of the rubber composition described above. The content of reinforcing fillers of the composition is as described previously. More particularly, in some embodiments, the composition comprises from 60 to 90 phr, preferably from 60 to 80 phr or from 60 to 78 phr, of reinforcing fillers, the reinforcing fillers consisting of a mixture of carbon black and pyrolysis carbon black. Preferably, the mixture therefore comprises from 30 to 60 phr of pyrolysis black and from 20 to 40 phr of carbon black.

Conventionally, the mounting support is a rim.

Irrespective of the embodiment described previously, the seating layer is arranged axially on the outside of the or each circumferential reinforcing element. The seating layer is thus arranged axially between the or each circumferential reinforcing element and the mounting support when the tyre is mounted on this support.

As indicated previously, tyres, in particular for passenger vehicles, usually include:
two beads intended to come into contact with a mounting support;
two sidewalls extending the beads radially outwards and coming together in a crown comprising a tread and a crown reinforcement;
at least one carcass reinforcement extending radially in each sidewall and axially in the crown, radially on the inside of the crown reinforcement.

The invention will be understood more clearly on reading the following description, which is given solely by way of non-limiting example and with reference to the drawings, in which:

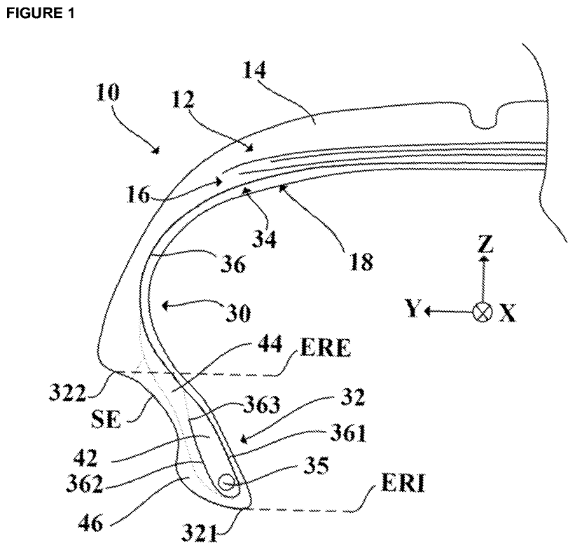

FIG. 1 is a view, in a meridian section plane parallel to the axis of rotation of the tyre, of a tyre according to a first embodiment of the invention,

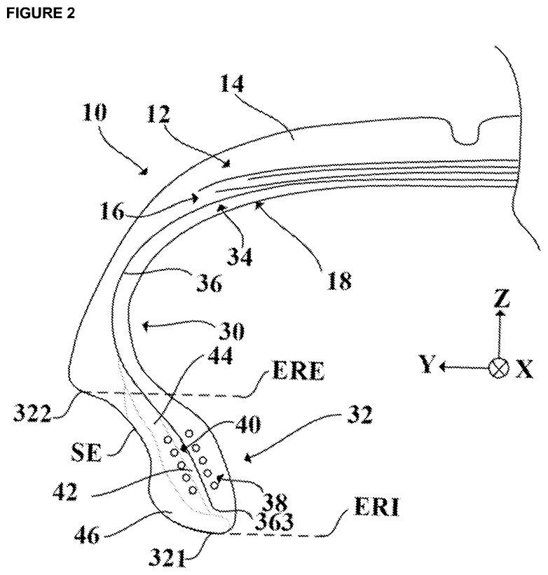

FIG. 2 is a view similar to that of FIG. 1 of a tyre according to a second embodiment.

A frame of reference X, Y, Z corresponding respectively to the usual axial (Y), radial (Z) and circumferential (X) directions of a tyre is shown in the figures relating to the tyre.

A frame of reference X, Y, Z corresponding respectively to the usual axial (Y), radial (Z) and circumferential (X) directions of a tyre is shown in the figures relating to the tyre.

FIG. 1 depicts a tyre in accordance with a first embodiment of the invention and denoted by the general reference 10. The tyre 10 has a substantially toroidal shape about an axis of revolution substantially parallel to the axial direction Y. The tyre 10 is intended for a passenger vehicle.

The tyre 10 comprises a crown 12 comprising a tread 14 intended to come into contact with the ground when it is running and a crown reinforcement 16 extending in the crown 12 in the circumferential direction X. The tyre 10 also comprises a leaktight inner layer 18 that is leaktight with respect to an inflation gas and is intended to delimit an internal cavity with a mounting support for the tyre 10, once the tyre 10 has been mounted on the mounting support, for example a rim, this cavity being intended to be pressurized with the inflation gas.

The tyre 10 comprises two sidewalls 30 that extend the crown 12 radially inwards. The tyre 10 also includes two beads 32 radially on the inside of the sidewalls 30. Each bead 32 is intended to come into contact with a mounting support. Each sidewall 30 connects each bead 32 to the crown 12. Thus, the two sidewalls 30 extend the beads 32 radially outwards and come together in the crown 12. Each bead 32 is delimited radially on the inside by the radially innermost point 321 of the tyre 1. Each bead 32 is delimited radially on the outside by the radially outermost point 322 of the outer surface SE of the bead 32 that is to be in contact with a measuring rim (not shown) of the tyre according to the ETRTO (European Tyre and Rim Technical Organization) standard manual, 2021 when the tyre is inflated to its nominal pressure on this measuring rim. The radially innermost point 321 defines the radially inner end ERI of the bead 32 and point 322 defines the radially outer end ERE of the bead 32.

The tyre 10 comprises a carcass reinforcement 34. The crown reinforcement 16 is arranged radially between the tread 14 and the carcass reinforcement 34. The carcass reinforcement 34 comprises at least one carcass layer 36, in this case a single carcass layer 36, anchored in each bead 32. The carcass layer 36 extends radially in each sidewall 30 and axially in the crown 12, radially on the inside of the crown reinforcement 16.

For the purpose of anchoring the carcass layer 36, the carcass layer 36 is anchored in each bead 32 by winding around a circumferential reinforcing element 35 of each bead 32, in this case a bead wire, such that an axially interior portion 361 of the carcass layer 36 anchored in each bead 32 is arranged axially on the inside of an axially exterior portion 362 of the carcass layer 36 anchored in each bead 32 and such that each axial end 363 axially delimiting the carcass layer 36 anchored in each bead 32 is arranged radially on the outside of each circumferential reinforcing element 35.

Each bead 32 includes a first layer 42, referred to as a filling layer, extending radially outwards from each circumferential reinforcing element 35 and in contact with the carcass layer 36. The first layer 42 is arranged, at least in part, between the axially interior portion 361 and the axially exterior portion 362.

Each bead 32 also includes a second layer 44, arranged axially on the outside of the axially exterior portion 362 and the first filling layer 42.

Each bead 32 also includes a third layer 46, known as the seating layer of the tyre 10. The third seating layer 46 is intended to be in contact with the mounting support for the tyre 10 when the tyre is mounted on this mounting support. The third seating layer 46 is arranged axially on the outside of the circumferential reinforcing element 35 and more precisely axially between the circumferential reinforcing element 35 and the mounting support (not shown) when the tyre is mounted on this support.

At least one of the first, second and third layers 42, 44, 46 comprises, preferably consists of, a rubber composition in accordance with the invention. In the example illustrated, the third seating layer 46 consists of a rubber composition in accordance with the invention. In particular, the rubber composition of the third seating layer 46 particularly comprises a plurality of elastomers; in particular, it comprises from 25 to 60 phr of natural rubber and from 40 to 75 phr of at least one polybutadiene.

FIG. 2 depicts a tyre according to a second embodiment of the invention. The elements similar to those illustrated in FIG. 1 are denoted by identical references.

Unlike the tyre according to the first embodiment, the tyre 10 according to the second embodiment is such that, for the purpose of anchoring the carcass layer 36, the tyre 10 comprises an axially interior circumferential reinforcing element 38 arranged axially on the inside of the carcass layer 36 and an axially exterior circumferential reinforcing element 40 arranged axially on the outside of the carcass layer 36. Here each reinforcing element 38, 40 comprises a continuous wire reinforcing element wound over a plurality of circumferential turns, for example as described in WO 2021/123522.

As with the first embodiment, at least one of the first, second and third layers 42, 44, 46 comprises, preferably consists of, a rubber composition in accordance with the invention. In the example illustrated, the third seating layer 46 consists of a rubber composition in accordance with the invention. In particular, the rubber composition of the third seating layer 43 particularly comprises one or more elastomers; in particular, it comprises from 40 to 100 phr of natural rubber and from 0 to 60 phr of at least one polybutadiene.

The tyre according to the invention is intended to equip motor vehicles of passenger vehicle type, SUVs (“Sport Utility Vehicles”), or two-wheel vehicles (notably motorcycles), or aircraft, or also industrial vehicles chosen from vans, heavy-duty vehicles—that is to say, underground trains, buses, heavy road transport vehicles (lorries, tractors, trailers) or off-road vehicles, such as heavy agricultural vehicles or civil engineering vehicles, and others. Preferably, the tyre according to the invention is particularly suitable for equipping vehicles of passenger vehicle, van and SUV type.

The examples that follow are given by way of illustration. They should not in any case be considered to limit the present invention.

### EXAMPLES

### Measurement Methods

### Tensile Test Measurements:

The tensile tests make it possible to determine the moduli of elasticity and the properties at break and are based on Standard NF ISO 37 of December 2005.

The nominal secant modulus (or apparent stress, in MPa, relative to the strain, which is unitless) is measured at 23 °C in second elongation (i.e. after an accommodation cycle at the extension rate provided for the measurement itself) at 10% elongation (denoted MA10).

The tearability indices are measured at 23 °C. The force to be exerted in order to obtain breaking (in N/mm) is determined in particular, and the strain at break (in %) is measured on a test specimen with dimensions of 10×85×2.5 mm notched at the centre of its length with 3 notches over a depth of 5 mm, in order to cause the test specimen to break.

Thus, the energy to cause the test specimen to break, which is the product of the breaking force and the breaking strain, can be determined.

The results are given in base 100, i.e. the values are expressed relative to a control, the measured value of which is considered as the reference at 100.

Thus, a lower value of the energy at break represents a decrease in tear strength performance (that is to say a decrease in the energy at break), whereas a higher value represents a better performance.

### Dynamic Properties:

The dynamic properties G* and tan(δ)max are measured on a viscosity analyser (Metravib V A4000) according to Standard ASTM D 5992-96. The response of a vulcanized composition sample (cylindrical test specimen with a thickness of 4 mm and a cross-section of 400 mm²), subjected to a simple alternating sinusoidal shear stress, at a frequency of 10 Hz, under variable temperature conditions, in particular at 23 °C, was recorded, according to Standard ASTM D 1349-99. A peak-to-peak strain amplitude sweep is carried out from 0.1% to 50% (outward cycle) and then from 50% to 1% (return cycle). The results made use of are the complex dynamic shear modulus (G*) and the loss factor (tan δ). The maximum value of tan δ observed (tan(δ)max) and the difference in complex modulus (ΔG*) between the values at 0.1% and 50% strain (Payne effect) are shown for the return cycle.

The lower the value of tan(δ) at 23 °C, the lower the hysteresis of the composition and thus the lower the rolling resistance.

The results are expressed in terms of performance in base 100, that is to say that the value 100 is arbitrarily assigned to the control, in order to subsequently compare the tan(δ) at 23 °C (that is to say, the hysteresis—and thus the rolling resistance) of the various solutions tested. The value in base 100 is calculated according to the operation: (tan(δ) value at 23 °C of the control/tan(δ) value at 23 °C of the sample)*100. In this way, a lower value represents a reduction in the hysteresis performance (that is to say, an increase in the hysteresis), while a higher value represents a better hysteresis performance (that is to say, a lower hysteresis).

### Preparation of the Compositions

The tests which follow are carried out in the following way: the diene elastomer, the reinforcing filler and also the various other ingredients, with the exception of the vulcanization system, are successively introduced into an internal mixer (final degree of filling: approximately 70% by volume), the initial vessel temperature of which is approximately 70 °C. Thermomechanical working (non-productive phase) is then carried out in one step, which lasts in total approximately 3 to 4 min, until a maximum “dropping” temperature of 165 °C is reached.

The mixture thus obtained is recovered and cooled and then sulfur and an accelerator (sulfenamide) are incorporated on a mixer (homofinisher) at 30 °C, everything being mixed (productive phase) for an appropriate time (for example between 5 and 12 min).

The compositions thus obtained are subsequently calendered, in the form of slabs (thickness of 2 to 3 mm) or of thin sheets of rubber, and are then subjected to a step of curing at 150 °C for 25 min, before the measurement of their physical or mechanical properties.

### Tests

Tests were carried out with different rubber compositions presented in Tables 1 and 2, based on natural rubber or on a blend of natural rubber and polybutadiene.

The composition T1 corresponds to a conventional composition used for forming the bead.

The compositions Ex 1 to Ex 6 correspond to compositions of use in the context of the present invention, with variable contents of carbon black and pyrolysis black, and also with increasing contents of crumb.

The compositions Ex 7 to Ex 10 correspond to compositions of use in the context of the present invention, with variable contents of carbon black and pyrolysis black, with or without the presence of crumb.

The compositions Ex1 to Ex10 are compositions which are advantageously of use with the tyre in accordance with the first embodiment described above.

Finally, the compositions Ex11 and 12 correspond to compositions of use in the context of the present invention, containing a blend of carbon blacks and pyrolysis blacks, and also crumbs with variations in the contents of natural rubber and polybutadiene. The latter compositions therefore cannot be compared analytically to the control composition T1, but make it possible to demonstrate the gain in performance over other elastomer matrices.

The compositions Ex11 and Ex12 are compositions which are advantageously of use with the tyre in accordance with the second embodiment described above.

Subsequently, in the cured state, i.e. after vulcanization, the elongation at break (EB), the breaking energy, the modulus of elasticity under tension at 10% elongation (MA₁₀), and the dynamic properties (G* at 10% elongation and tan(δ)max) are measured.

The properties of the compositions are presented in Tables 1 and 2.

TABLE 1

| | T1 | Ex 1 | Ex 2 | Ex 3 | Ex 4 | Ex 5 | Ex 6 |
|---|---|---|---|---|---|---|---|
| NR (1) | 50 | 50 | 50 | 50 | 50 | 50 | 50 |
| BR (2) | 50 | 50 | 50 | 50 | 50 | 50 | 50 |
| Carbon black (3) | 65 | 35 | 35 | 50 | 35 | 20 | 35 |
| Pyrolysis black (4) | 0 | 35 | 35 | 18 | 35 | 53 | 35 |
| Crumb rubber (5) | 0 | 6 | 10 | 15 | 15 | 15 | 20 |
| Resin (7) | 1 | 1 | 1 | 1 | 1 | 1 | 1 |
| Antioxidants (8) | 4 | 4 | 4 | 4 | 4 | 4 | 4 |
| Antiozone wax (9) | 1 | 1 | 1 | 1 | 1 | 1 | 1 |
| Sulfur (10) | 2.0 | 2.0 | 2.1 | 2.1 | 2.1 | 2.1 | 2.2 |
| Stearic acid (11) | 1.5 | 1.5 | 1.5 | 1.5 | 1.5 | 1.5 | 1.5 |
| Accelerator (12) | 1.1 | 1.1 | 1.2 | 1.2 | 1.2 | 1.2 | 1.2 |
| Zinc oxide (13) | 4 | 4 | 4 | 4 | 4 | 4 | 4 |
| MA10 at 23° C. (MPa) | 100 | 98 | 95 | 95 | 96 | 100 | 98 |
| Base 100 | | | | | | | |
| G*10% at 23° C. (MPa) | 100 | 91 | 96 | 95 | 94 | 93 | 95 |
| Base 100 | | | | | | | |
| Tearability | 100 | 227 | 226 | 214 | 221 | 208 | 217 |
| elongation at break | | | | | | | |
| EB at 23° C. (%) | | | | | | | |
| Base 100 | | | | | | | |
| Tearability stress at | 100 | 223 | 208 | 198 | 208 | 192 | 204 |
| break FR at 23° C. | | | | | | | |
| (N/mm) | | | | | | | |
| Base 100 | | | | | | | |
| Tearability energy at | 100 | 396 | 470 | 424 | 458 | 401 | 444 |
| break at 23° C. (mJ) | | | | | | | |
| Base 100 | | | | | | | |
| Tan delta max at | 100 | 114 | 113 | 106 | 108 | 117 | 109 |
| 23° C. | | | | | | | |
| Base 100 | | | | | | | |

Formulations (contents expressed as phr) and properties of compositions T1 and Ex1 to Ex6.
(1) Natural rubber
(2) Polybutadiene
(3) Carbon black, ASTM N550 grade from Cabot; BET (according to ASTM D6556-10): 39 m²/g, COAN: 85 ml/100g
(4) P550 pyrolysis carbon black from Scandinavian Enviro Systems (ash (%): 18.5; sulfur (%): 3; zinc (%): 4.5; STSA specific surface area: 56 m²/g (ASTM D6556-2021); void volume at 50 MPa: 44 ml/100 g (ASTM D7854-21))
(5) PolyDyne crumb rubber-Lehigh; particle size distribution (according to ASTM D5644-01): 60 mesh <12%
(7) Oleorosin
(8) Combination of two antioxidants TMQ ((N-(1,3-dimethylbutyl)-N-phenyl-paraphenylenediamine (Santoflex 6-PPD from Flexsys) and 2,2,4-trimethyl-1,2-dihydroquinolone (TMQ from Lanxess)
(9) Varazon 4959 wax from Sasol
(10) Sulfur
(11) Pristerene 4931 stearic acid from Uniqema
(12) N-(tert-Butyl)-2-benzothiazolesulfenamide (Santocure TBBS) from Flexsys
(13) Zinc oxide, industrial grade, from Umicore

TABLE 2

| | T1 | Ex 7 | Ex 8 | Ex 9 | Ex10 | Ex11 | Ex12 |
|---|---|---|---|---|---|---|---|
| NR (1) | 50 | 50 | 50 | 50 | 50 | 70 | 100 |
| BR (2) | 50 | 50 | 50 | 50 | 50 | 30 | 0 |
| Carbon black (3) | 65 | 37 | 21 | 37 | 21 | 34 | 36 |
| Pyrolysis black (4) | 0 | 38 | 56 | 38 | 56 | 33 | 36 |
| Crumb rubber (5) | 0 | 0 | 0 | 15 | 15 | 15 | 15 |
| Oil (6) | 0 | 4 | 4 | 4 | 4 | 0 | 0 |
| Resin (7) | 1 | 2 | 2 | 2 | 2 | 5 | 5 |
| Antioxidants (8) | 4 | 4 | 4 | 4 | 4 | 4 | 4 |
| Antiozone wax (9) | 1 | 1 | 1 | 1 | 1 | 1 | 1 |
| Sulfur (10) | 2 | 2.2 | 2.2 | 2.4 | 2.4 | 2.7 | 2.7 |
| Stearic acid (11) | 1.5 | 1.5 | 1.5 | 1.5 | 1.5 | 3 | 3 |
| Accelerator (12) | 1.1 | 1.2 | 1.2 | 1.3 | 1.3 | 1.3 | 1.3 |
| Zinc oxide (13) | 4 | 4 | 4 | 4 | 4 | 4 | 4 |
| MA10 at 23° C. | 100 | 99 | 96 | 100 | 94 | 102 | 103 |
| (MPa) Base 100 | | | | | | | |
| G*10% at 23° C. | 100 | 103 | 98 | 108 | 101 | 106 | 110 |
| (MPa) Base 100 | | | | | | | |
| Tearability elongation | 100 | 151 | 150 | 139 | 136 | 153 | 126 |
| at break EB at | | | | | | | |
| 23° C. (%) Base 100 | | | | | | | |
| Tearability stress at | 100 | 131 | 120 | 118 | 107 | 138 | 126 |
| break FR at 23° C. | | | | | | | |
| (N/mm) Base 100 | | | | | | | |
| Tearability energy at | 100 | 198 | 180 | 163 | 146 | 211 | 159 |
| break at 23° C. (mJ) | | | | | | | |
| Base 100 | | | | | | | |
| Tan delta max at | 100 | 101 | 108 | 95 | 101 | 95 | 80 |
| 23° C .Base 100 | | | | | | | |

Formulations (contents expressed as phr) and properties of compositions T1 and Ex7 to Ex12.
(1) Natural rubber
(2) Polybutadiene
(3) Carbon black, ASTM N550 grade from Cabot; BET (according to ASTM D6556-
10): 39 m²/g, COAN: 85 ml/100g
(4) P550 pyrolysis carbon black from Scandinavian Enviro Systems (ash (%): 18.5; sulfur (%): 3; zinc (%): 4.5; STSA specific surface area: 56 m²/g (ASTM D6556-2021); void volume at 50 MPa: 44 ml/100 g (ASTM D7854-21))
(5) PolyDyne crumb rubber-Lehigh; particle size distribution (according to ASTM D5644-01): 60 mesh <12%
(6) Vivatec 500 TDAE oil from H&R
(7) Oleorosin
(8) Combination of two antioxidants TMQ ((N-(1,3-dimethylbutyl)-N-phenyl-paraphenylenediamine (Santoflex 6-PPD from Flexsys) and 2,2,4-trimethyl-1,2-dihydroquinolone (TMQ from Lanxess)
(9) Varazon 4959 wax from Sasol
(10) Sulfur
(11) Pristerene 4931 stearic acid from Uniqema
(12) N-(tert-Butyl)-2-benzothiazolesulfenamide (Santocure TBBS) from Flexsys
(13) Zinc oxide, industrial grade, from Umicore

It can be observed that the compositions of use in the context of the invention (Ex1 to 10) have the same stiffness/hysteresis balance, or even a better stiffness/hysteresis balance in the case of Ex 1 to 6, than the control composition (T1), while having an improved tearability energy at break, reflecting better cohesion of the material and resistance to attacks.

1.-15. (canceled)

16. A tire comprising two beads, at least one of the beads comprising a rubber composition based on:
at least one elastomer;
60 to 100 phr of reinforcing fillers, of which 15 to 70 phr are pyrolysis carbon black and 15 to 60 phr are carbon black, with a total content of carbon black and pyrolysis carbon black ranging from 60 to 90 phr; and
a crosslinking system.

17. The tire according to claim 16, wherein the at least one elastomer is a diene elastomer selected from the group consisting of polybutadienes (BR), natural rubber (NR), synthetic polyisoprenes (IR), butadiene copolymers, isoprene copolymers and mixtures thereof.

18. The tire according to claim 16, wherein the rubber composition comprises from 25 to 100 phr of natural rubber and from 0 to 75 phr of at least one polybutadiene.

19. The tire according to claim 16, wherein the rubber composition comprises from 60 to 80 phr of reinforcing fillers, the reinforcing fillers consisting of a mixture of carbon black and pyrolysis carbon black.

20. The tire according to claim 19, wherein the mixture of carbon black and pyrolysis carbon black comprises from 20 to 40 phr of carbon black and from 30 to 60 phr of pyrolysis carbon black.

21. The tire according to claim 16, wherein the pyrolysis carbon black has an ash content ranging from 5% to 30% by weight, relative to a total weight of the pyrolysis carbon black.

22. The tire according to claim 16, wherein the pyrolysis carbon black has a sulfur content of greater than 2% by weight, relative to a total weight of the pyrolysis carbon black.

23. The tire according to claim 16, wherein the composition further comprises crumb rubbers.

24. The tire according to claim 16, wherein the crosslinking system is a vulcanization system based on molecular sulfur and/or on a sulfur-donating agent.

25. The tire according to claim 16, wherein the rubber composition further comprises one or more agents selected from the group consisting of plasticizers, non-reinforcing fillers, pigments, protective agents, chemical anti-ozonants, antioxidants, anti-fatigue agents and reinforcing resins.

26. The tire according to claim 16, further comprising a carcass reinforcement comprising at least one carcass layer anchored in each bead, winding around a circumferential reinforcing element of each bead such that an axially interior portion of the at least one carcass layer anchored in each bead is arranged axially on an inside of an axially exterior portion of the at least one carcass layer anchored in each bead.

27. The tire according to claim 26, wherein the rubber composition comprises from 25 to 60 phr of natural rubber and from 40 to 75 phr of at least one polybutadiene.

28. The tire according to claim 16, further comprising a carcass reinforcement comprising at least one carcass layer anchored in each bead, each bead comprising an axially interior circumferential reinforcing element arranged axially on an inside of the at least one carcass layer anchored in each bead and an axially exterior circumferential reinforcing element arranged axially on an outside of the at least one carcass layer anchored in each bead.

29. The tire according to claim 28, wherein the rubber composition comprises from 40 to 100 phr of natural rubber and from 0 to 60 phr of at least one polybutadiene.

30. The tire according to claim 16, wherein the at least one of the beads comprises a tire seating layer intended to be in contact with a mounting support for the tire when the tire is mounted on the mounting support, the seating layer comprising the rubber composition.

31. The tire according to claim 16, wherein the pyrolysis carbon black has an ash content ranging from 8% to 25% by weight, relative to a total weight of the pyrolysis carbon black.

32. The tire according to claim 16, wherein the pyrolysis carbon black has a sulfur content ranging from 2.5% to 5% by weight, relative to a total weight of the pyrolysis carbon black.

33. The tire according to claim 16, wherein the rubber composition further comprises crumb rubbers at a content of greater than 0 phr and less than or equal to 20 phr.

34. The tire according to claim 16, wherein the crosslinking system is a vulcanization system based on molecular sulfur and/or on a sulfur-donating agent comprising between 0.5 and 10 phr of sulfur.

35. The tire according to claim 34, wherein the vulcanization system based on molecular sulfur and/or on a sulfur-donating agent comprises between 1 and 5 phr of sulfur.

36. The tire according to claim 35, wherein the at least one of the beads comprises a tire seating layer intended to be in contact with a mounting support for the tire when the tire is mounted on the mounting support, the seating layer consisting of the rubber composition.
